(19) United States
(12) Patent Application Publication
(10) Pub. No.: US 2006/0201962 A1
(43) Pub. Date: Sep. 14, 2006

(54) Automated capsule counting apparatus

(75) Inventor: Sheng-Hui Yang, Taichung City (TW)

Correspondence Address: FOLEY AND LARDNER LLP;SUITE 500, 3000 K STREET NW, WASHINGTON, DC, 20007, US

(73) Assignee: CVC TECHNOLOGIES, INC.

(21) Appl. No.: 11/076,520

(22) Filed: Mar. 10, 2005

(51) Int. Cl. G07F 11/00

(52) U.S. Cl. 221/13

(57) ABSTRACT

An automated capsule counting apparatus includes a chute body, a stop plate, a conveyor unit, a light transceiver unit, and a control unit. The chute body has an upper chute portion with an open inlet end, and a lower chute portion with an open discharge end. The stop plate extends into the chute body between the upper and lower chute portions, and is movable for permitting and preventing spatial communication between the inlet end and the discharge end. The conveyor unit is adapted for transferring capsules into the chute body via the inlet end. The light transceiver unit includes a plurality of light transmitter and light receiver pairs for forming optical sensing paths to be interrupted by the capsules transferred into the chute body. The control unit controls movement of the stop plate based on number of the capsules transferred and detected by the light transceiver unit.

### BACKGROUND OF THE INVENTION

1. Field of the Invention

The invention relates to a counting apparatus, more particularly to an automated capsule counting apparatus suitable for filling containers with capsules.

2. Description of the Related Art

Counting devices used in the drug and food industries for counting drugs or food pellets are normally based on any one of the following techniques: (1) counting by weighing; (2) counting by making contact with the pellets; and (3) detection using optical switches. However, the known counting devices are configured to serve only a counting purpose. In addition, the counting speed is rather slow.

### SUMMARY OF THE INVENTION

Therefore, the main object of the present invention is to provide an automated capsule counting apparatus that can overcome at least one of the aforesaid drawbacks of the prior art.

Accordingly, an automated capsule counting apparatus of this invention comprises a hopper unit, a conveyor unit, a light transceiver unit, and a control unit.

The hopper unit includes a chute body and a stop plate. The chute body has an upper chute portion with an open inlet end, and a lower chute portion with an open discharge end. The stop plate extends into the chute body between the upper and lower chute portions, and is movable between opening and closing positions for respectively permitting and preventing spatial communication between the inlet end and the discharge end.

The conveyor unit is adapted for transferring capsules into the chute body via the inlet end of the upper chute portion.

The light transceiver unit includes a plurality of light transmitter and light receiver pairs forming optical sensing paths interrupted by the capsules transferred into the chute body.

The control unit is coupled to the hopper unit and the light transceiver unit, and controls movement of the stop plate based on number of the capsules transferred into the chute body and detected by the light transceiver unit.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view to illustrate a hopper unit and a conveyor unit of the preferred embodiment of an automated capsule counting apparatus according to the present invention, in which a stop plate of the hopper unit is in an opening position;

FIG. 2 is a view similar to FIG. 1, but illustrating the stop plate in a closing position;

FIG. 3 is a block diagram illustrating components of the preferred embodiment;

FIG. 4 is a fragmentary schematic side view of the preferred embodiment, illustrating the stop plate in the closing position;

FIG. 5 is a circuit diagram of a light transmitter of the preferred embodiment;

FIG. 6 is a circuit diagram of a light receiver of the preferred embodiment;

FIG. 7 is a block diagram for illustrating signal transmission within a control unit of the preferred embodiment;

FIG. 8 is a block diagram for illustrating time-division multiplexing infrastructure for the control unit of the preferred embodiment;

FIG. 9 illustrates enable signals for activating a bus set for the control unit of the preferred embodiment;

FIG. 10 illustrates how a capsule is represented using a pixel array;

FIG. 11 is a plot of voltage vs. detected intensity for a light receiver of the preferred embodiment; and

FIG. 12 is a flowchart to illustrate light intensity adjustment for a light transmitter of the preferred embodiment.

### DETAILED DESCRIPTION OF THE PREFERRED EMBODIMENT

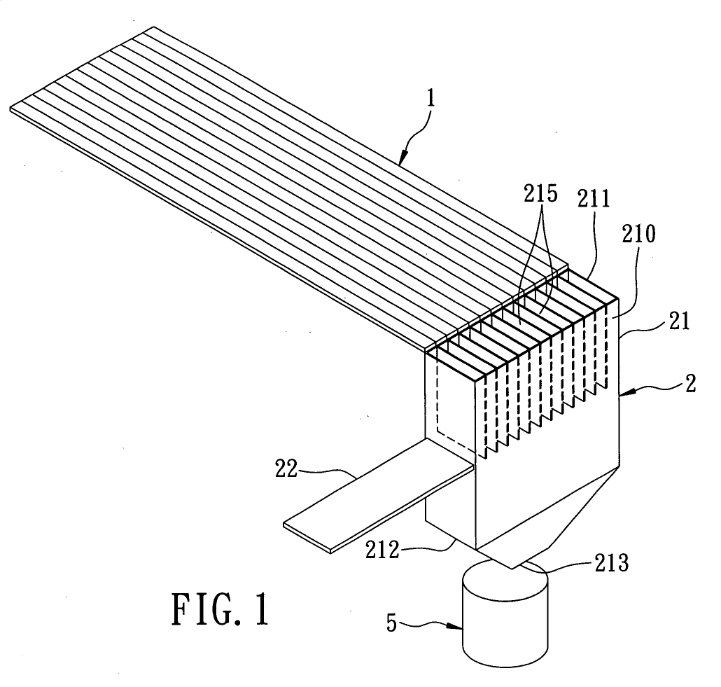

Referring to FIGS. 1 to 3, the preferred embodiment of an automated capsule counting apparatus according to the present invention is shown to include a hopper unit 2, a conveyor unit 1, a light transceiver unit 3, and a control unit 4.

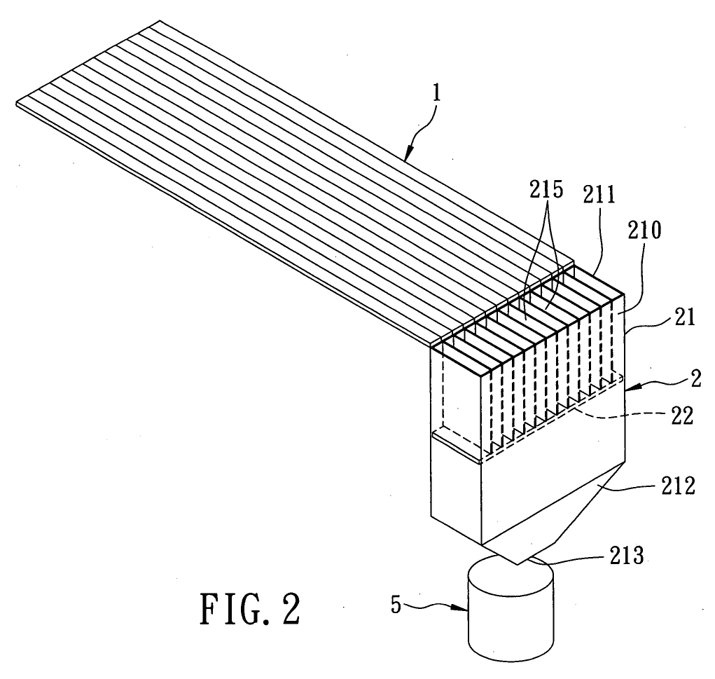

The hopper unit 2 includes a chute body 21 and a stop plate 22. In this embodiment, the chute body 21 is made of a light permeable material, and has an upper chute portion 210 with an open inlet end 211, and a lower chute portion 212 with an open discharge end 213. The stop plate 22 extends into the chute body 21 between the upper and lower chute portions 210, 212, and is movable between an opening position (see FIG. 1) and a closing position (see FIG. 2) for respectively permitting and preventing spatial communication between the inlet end 211 and the discharge end 213. Preferably, the upper chute portion 210 of the chute body 21 is partitioned into a plurality of channels 215 that are transverse to the stop plate 22. In this embodiment, the number of channels 215 is twelve.

The conveyor unit 1 is adapted for transferring capsules into the chute body 21 via the inlet end 211 of the upper chute portion 210.

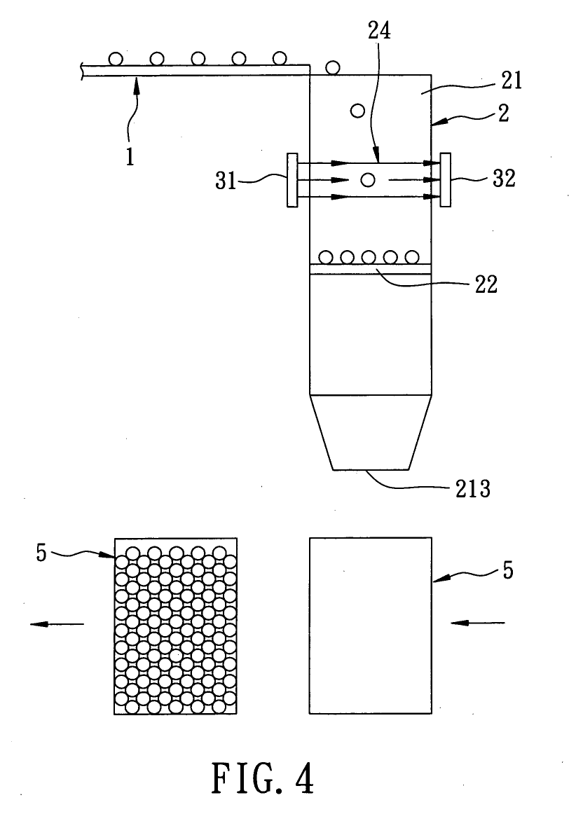

With further reference to FIG. 4, the light transceiver unit 3 can control the intensity of each light beam emitted thereby. In this embodiment, the light transceiver unit 3 is configured for emitting infrared light, and there are sixteen intensity levels for each emitted light beam. The light transceiver unit 3 includes pairs of light transmitters 31 and light receivers 32 that are disposed on opposite sides of the chute body 21. In this embodiment, the light transmitter and light receiver pairs of the light transceiver unit 3 are distributed among the channels 215 in the upper chute portion 210 of the chute body 21 such that each of the channels 215 has an optical sensing path 24. In particular, the optical sensing path 24 in each of the channels 215 is defined by eight light beams that are emitted by the light transceiver unit 3. The optical sensing paths 24 in the channels 215 are interrupted by the capsules transferred into the chute body 21. Interruption of the optical sensing paths 24 is then detected by the light receivers 32, which generate capsule-detected signals accordingly.

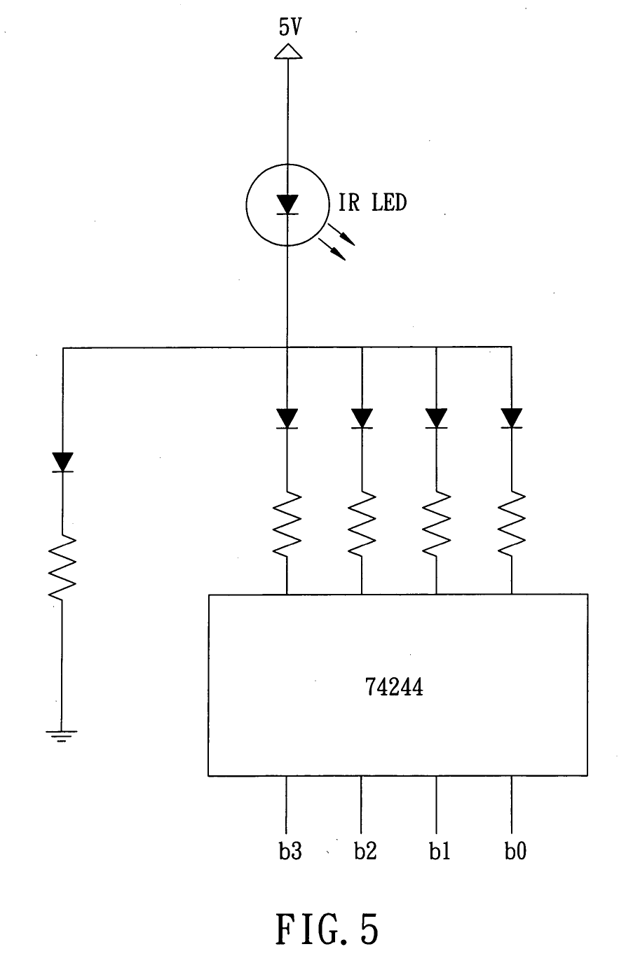

Referring to FIG. 5, each light transmitter 31 is built as a digital-to-analog converter (DAC) that includes a buffer (IC 74244), a plurality of resistors, and a light-emitting diode (IR LED).

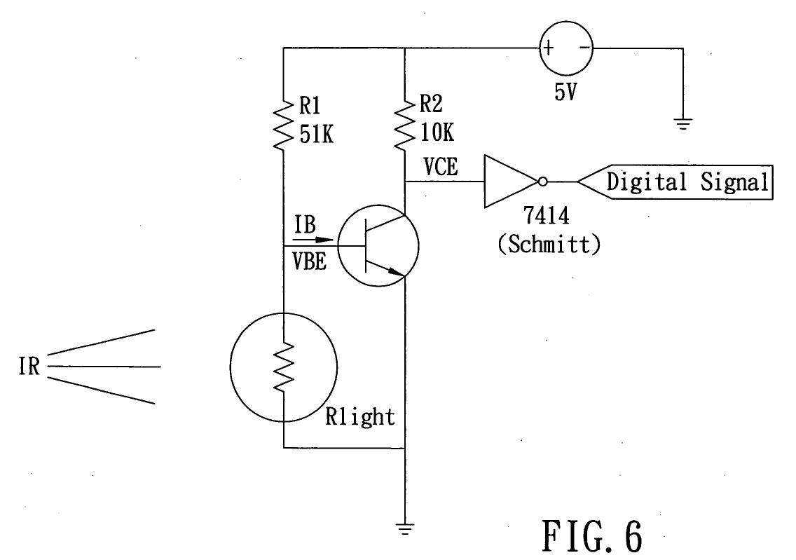

Referring to FIG. 6, each light receiver 32 has a design based on the characteristics of a light-sensitive resistor (Rlight) thereof. When the optical sensing path 24 is not interrupted by a capsule, the light-sensitive resistor (Rlight) receives a high intensity of infrared light from the light transmitter 31, and the resistance thereof increases. As a result, the base-emitter voltage (VBE) of a transistor of the light receiver 32 becomes large, and the collector-emitter voltage (VCE) of the transistor drops. On the other hand, when the optical sensing path 24 is interrupted by a capsule, the intensity of light received by the light-sensitive resistor (Rlight) becomes low, and the resistance thereof drops. As a result, the base-emitter voltage (VBE) becomes small, and the collector-emitter voltage (VCE) increases. In this manner, changes in voltage signals are generated for subsequent amplification by an amplifier (IC 7414, which is a NOT gate with a Schmitt trigger circuit) to result in a digital capsule-detected signal that is outputted to the control unit 4.

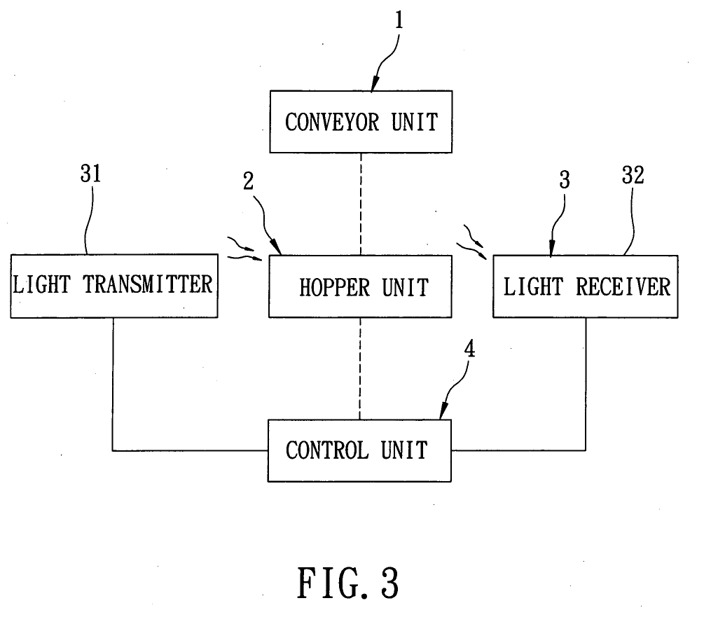

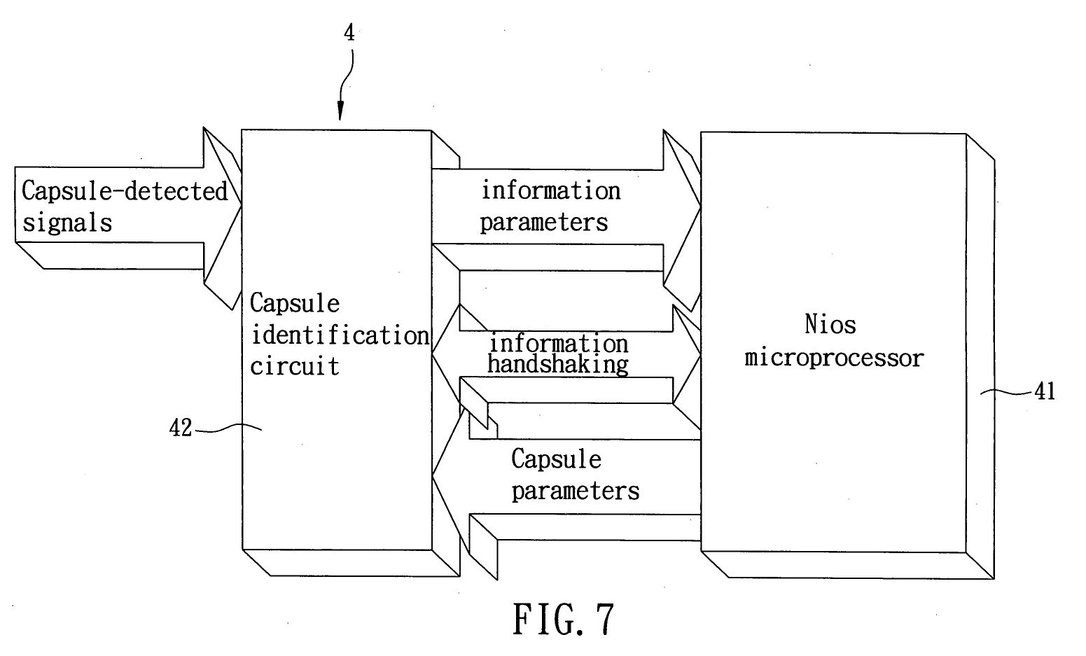

Referring to FIGS. 3, 4 and 7, the control unit 4 is coupled to the hopper unit 2 and the light transceiver unit 3, and includes a Nios microprocessor 41 and a capsule identification circuit 42 that includes capsule data firmware. The control unit 4 can receive input capsule parameters and capsule-detected signals, and controls movement of the stop plate 22 based on number of the capsules transferred into the chute body 2 and detected by the light transceiver unit 3.

In operation, the Nios microprocessor 41 monitors sequentially capsule-detected data of the channels 215, and responds based on the information parameters received thereby. The information parameters can include:

1. Valid Pill: This indicates the transfer of a valid capsule.

2. Invalid Length: This indicates the transfer of an invalid capsule, which has a length that is either too long or too short, such as when one capsule is stuck to another capsule or is broken.

3. Invalid Size: This indicates the transfer of an invalid capsule, which has a size that is either too big or too small due to the same reasons as Invalid Length.

4. Invalid Period: The transfer time between two consecutive capsules is too short, which can cause difficulty during capsule number control and which requires remedial measures, such as slowing down the speed of the conveyer unit.

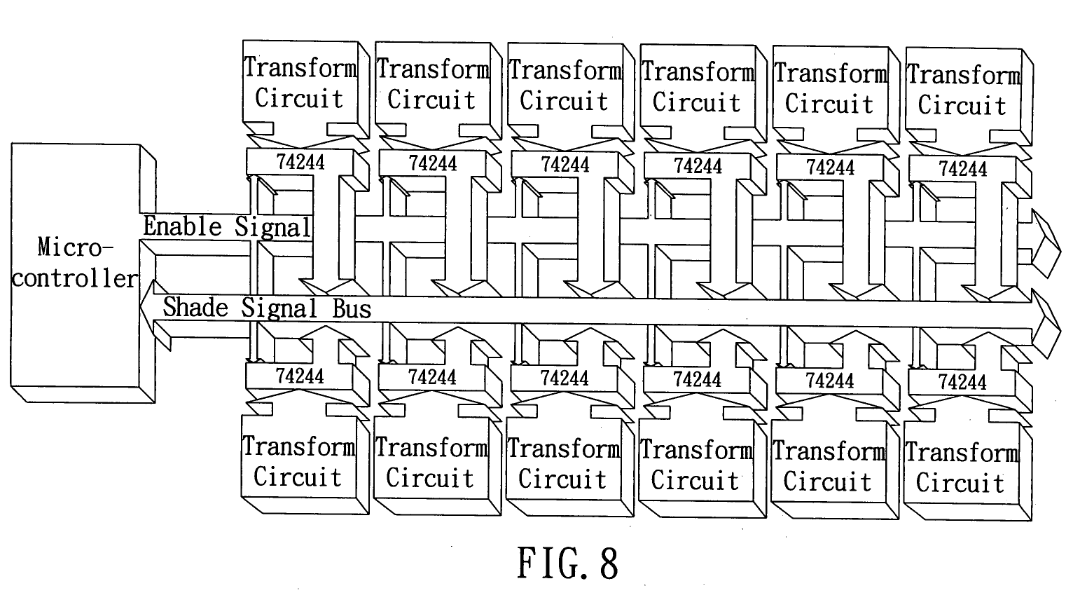

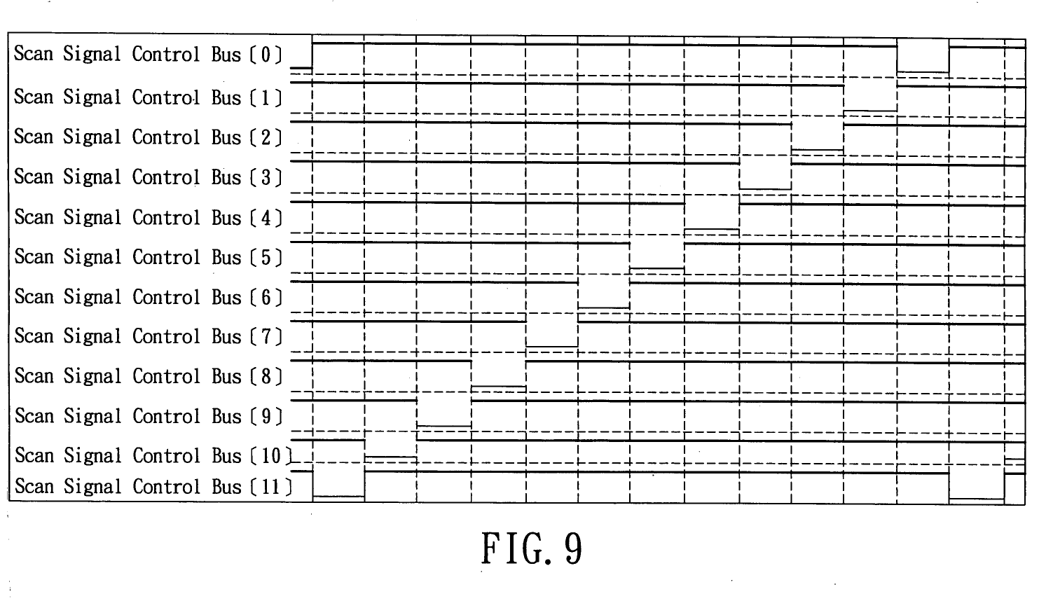

Since there are twelve channels 215, there are a total of 8 (number of light-sensitive resistors per channel)×12 or 96 signal lines for capsule-detected signals. It would be a waste of terminal connections if all 96 signal lines were connected directly to the control unit 4. In this embodiment, a concept of time-division multiplexing for bus lines is applied to reduce the 96 signal lines to eight. Referring to FIGS. 8 and 9, there are twelve buffers that correspond respectively to the channels 215 and that output high impedance when in a disabled state (1G_n=0, 2G_n=0). By configuring the Nios microprocessor 41 of the control unit 4 to enable the buffers for the channels 215 at different time periods, and to retrieve in sequence current states of the channels 215, the Nios microprocessor 41 is able to perform subsequent operations, such as verification of the transfer of a capsule into one of the channels 215, counting of the number of transferred capsules, etc.

In addition, capsule containers 5 (see FIG. 4) are to be disposed in sequence under the lower chute portion 212 of the chute body 21 so as to receive the capsules that fall out from the discharge end 213.

In the preferred embodiment, the control unit 4 is further capable of identifying and analyzing dimensions of the capsules transferred into the chute body 21 based on the output of the light transceiver unit 3 as follows:

1) Identification of Capsule Length:

Capsule length is measured by counting the number of clock cycles when the optical sensing path 24 is interrupted by a transferred capsule. The user can input standard values of length, width, height, and length vs. interruption time beforehand in the form of tables. When parameters of a specific capsule are inputted, the Nios microprocessor 41 looks up the tables, and outputs corresponding interruption time information for a valid capsule length to the capsule identification circuit 42. A valid interruption time (T_{valid}) is defined as follows:
table(min(l,w,h)) [symbol] T_{valid} [symbol] \sqrt{l²+w²+h²}

in which l, w, h are the length, width and height of the capsule respectively, and Table( ) is a look-up operation for the length vs. interruption time table.

In other embodiments, the Nios microprocessor 41 is provided with a heuristic algorithm for capsule length determination. In other words, when a certain amount of valid capsules is transferred into the channels 215, the Nios microprocessor 41 is able to set a valid interruption time corresponding thereto.

2) Identification of Capsule Size:

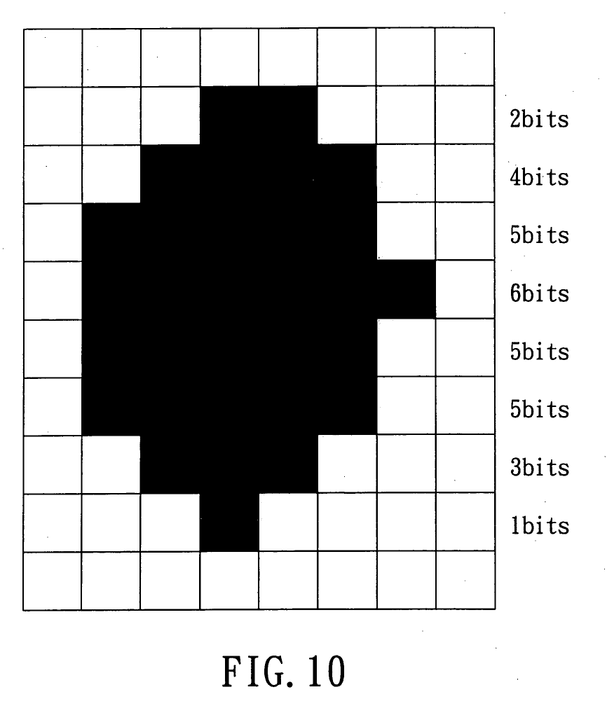

Referring to FIG. 10, the total area shaded by a capsule when the latter interrupts an optical sensing path 24 may be calculated to give an indication as to whether or not the capsule has a valid size. The length, width and height inputted for a specific capsule are initially computed by the Nios microprocessor 41 to obtain upper and lower limit information of a projected shadow of the capsule over a pixel array. The capsule identification circuit 42 then determines whether the dimensions of the area shaded by a transferred capsule falls within the upper and lower limit information.

Referring again to FIGS. 1, 2 and 4, apart from determining conditions of transferred capsules, the control unit 4 is also able to count the number of transferred capsules. As shown in FIG. 1, when the stop plate 22 is in the opening position, the capsules transferred into the chute body 21 fall into a capsule container 5 via the discharge end 213 of the lower chute body 212. When a predetermined number of the capsules had fallen into the capsule container 5, the control unit 4 controls the stop plate 22 to move to the closing position, as best shown in FIG. 2, and resets the count. Thereafter, even if the conveyor unit 1 keeps on transferring capsules into the chute body 21, the transferred capsules will be retained in the chute body 21 by the stop plate 22 until a previously filled capsule container 5 has been replaced by an empty one. The stop plate 22 is then controlled to move to the opening position for filling the empty capsule container 5.

It is worth noting that, during capsule counting, it is inevitable for dust and other particles to fall on the optical sensing path 24. These may be detected by the light receivers 32, and are thus a source of noise. To minimize their effect, the intensity of infrared light emitted by the light transmitters 31 may be increased to correspond with actual ambient conditions, thus altering the response of the light-sensitive resistors of the light receivers 32. The underlying principle for the same is as follows:

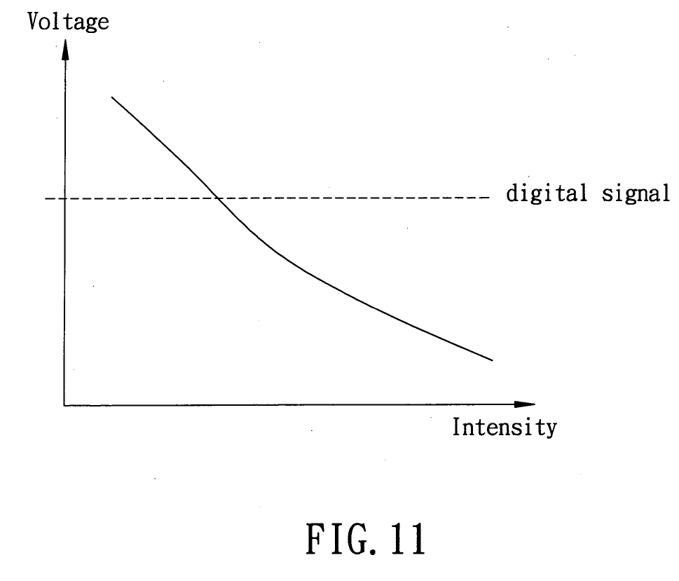

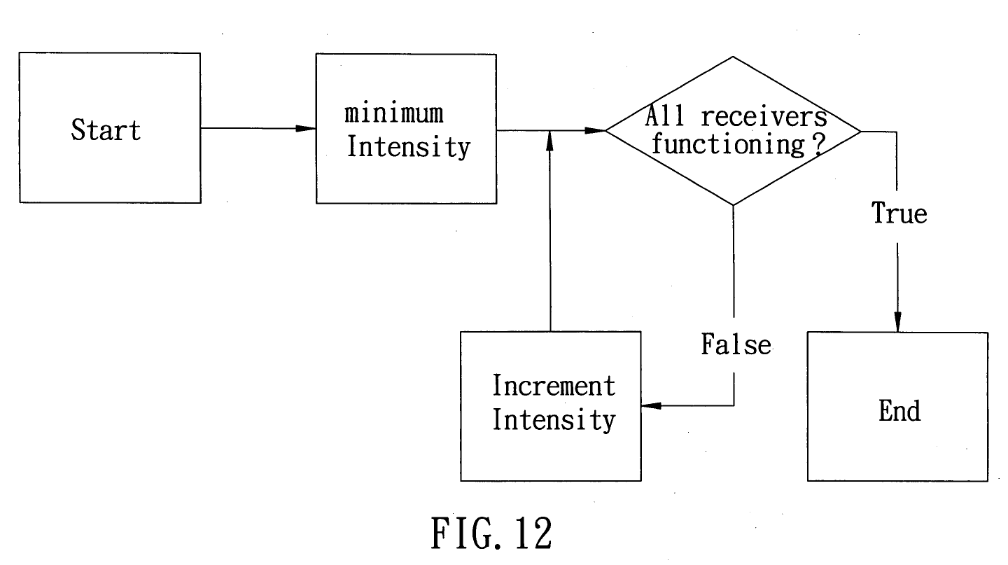

Referring to FIGS. 6 and 11, when the collector-emitter voltage drops below a digital signal level, the amplifier determines the signal to be a digital low (i.e., the Nios microprocessor 41 is able to determine whether or not the optical sensing path 24 is in an interrupted state). The response time for the light-sensitive resistor is typically 10˜15 ms. Hence, if the light intensity is high, the time period needed for the voltage to return to the digital signal level is lengthened. As a result, when similar capsules are transferred, different capsule measurements may result for the different channels. To resolve this issue, referring to FIG. 12, during an initialization process, the control unit 4 controls the light transmitters 31 to emit infrared light in each of the channels 215 such that the intensity thereof enables the light receivers 32 to generate the appropriate voltage corresponding to the critical position of the digital signal level, thereby maintaining sensitivity of the light receivers 32 so as to overcome the adverse effects that are attributed to dust, small particles, ambient temperature, ambient humidity, etc., and thereby ensuring high accuracy in the apparatus of this invention.

It has thus been shown that the apparatus of this invention is not only capable of performing the basic function of capsule counting at a relatively fast speed, but is further operable so as to provide useful capsule information.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. An automated capsule counting apparatus comprising:
a hopper unit including
a chute body having an upper chute portion with an open inlet end, and a lower chute portion with an open discharge end, and
a stop plate extending into said chute body between said upper and lower chute portions, said stop plate being movable between opening and closing positions for respectively permitting and preventing spatial communication between said inlet end and said discharge end;
a conveyor unit adapted for transferring capsules into said chute body via said inlet end of said upper chute portion;
a light transceiver unit including a plurality of light transmitter and light receiver pairs forming optical sensing paths interrupted by the capsules transferred into said chute body; and
a control unit coupled to said hopper unit and said light transceiver unit, said control unit controlling movement of said stop plate based on number of the capsules transferred into said chute body and detected by said light transceiver unit.

2. The automated capsule counting apparatus as claimed in claim 1, wherein said upper chute portion of said chute body is partitioned into a plurality of channels that are transverse to said stop plate.

3. The automated capsule counting apparatus as claimed in claim 2, wherein said light transmitter and light receiver pairs of said light transceiver unit are distributed among said channels in said upper chute portion of said chute body such that each of said channels has one of said optical sensing paths.

4. The automated capsule counting apparatus as claimed in claim 3, wherein said optical sensing path in each of said channels is defined by eight light beams emitted by said light transceiver unit.

5. The automated capsule counting apparatus as claimed in claim 1, wherein said light transmitters of said light transceiver unit are controllable to vary a light intensity output thereof to correspond with actual ambient conditions.

6. The automated capsule counting apparatus as claimed in claim 1, further comprising a capsule container to be disposed under said lower chute portion of said chute body so as to receive the capsules that fall out from said discharge end.

7. The automated capsule counting apparatus as claimed in claim 6, wherein said control unit controls movement of said stop plate such that a predetermined number of the capsules fall into said capsule container.

8. The automated capsule counting apparatus as claimed in claim 1, wherein said control unit is further capable of identifying and analyzing dimensions of the capsules transferred into said chute body based on output of said light transceiver unit.
